(19) United States
(12) Patent Application Publication
(10) Pub. No.: US 2013/0269629 A1
(43) Pub. Date: Oct. 17, 2013

(54) MAGNETIC BUCKLE FOR A PET COLLAR OR THE LIKE

(71) Applicant: COASTAL PET PRODUCTS, INC., Alliance, OH (US)

(72) Inventor: Robert C. HOLT, JR., North Canton, OH (US)

(73) Assignee: COASTAL PET PRODUCTS, INC., Alliance, OH (US)

(21) Appl. No.: 13/793,004

(22) Filed: Mar. 11, 2013

Related U.S. Application Data
(60) Provisional application No. 61/623,624, filed on Apr. 13, 2012.

(51) Int. Cl. A44B 11/00; A01K 27/00

(52) U.S. Cl. CPC A44B 11/00; A01K 27/001
USPC 119/863; 24/303

(57) ABSTRACT

A buckle (10) is preferably formed of identical portions (11) each including a metallic base member (12) and a plastic cover (22) molded around a portion of the base member (12). The base member includes a first flange (14) having a slot (16) therein, and a second flange (15) having an opening (18) therein. The cover (22) includes a body portion (23) which carries a magnet (25). A tab (26) and projection (27) form a hook on the body portion (23), and a slot (29) is formed on the body portion (23). When the two portions (11) are attached together to form the buckle (10), the magnets (25) are adjacent to each other and the hook of one portion (11) is received in the slot (29) of the other portion (11). To form a collar (30), one end of a strap (31) is attached to a portion (11) through the slot (16) and the other end of the strap (31) is attached through the other portion (11) through its slot (16). The openings (18) are also aligned so that a leash or the like may be connected to the buckle (10).

### CROSS-REFERENCE TO RELATED APPLICATION

This application claims priority from U.S. Provisional Patent Application Ser. No. 61/623,624 filed Apr. 13, 2012, which is incorporated herein by reference in its entirety.

### TECHNICAL FIELD

This invention relates to a magnetic buckle of the type which may be used for pet collars, harnesses or like strap products. More particularly, this invention relates to a magnetic buckle including first and second preferably identical magnetic coupling devices adapted to be secured to a strap, the coupling devices being releasably and magnetically secured together.

### BACKGROUND ART

Pet collars and harnesses are well known, and are available in a wide variety of configurations and with many different features. Many of these known collars and harnesses include one or both of a buckle for attaching the ends of adjacent straps together and a leash connector for securing a leash for lead to the collar or harness. The buckle provides a releasable mechanism for securing the collar or harness on an animal. The leash connector facilitates attachment of a leash typically associated with such collars and harnesses by providing a convenient anchoring point for the hook or other connecting device provided on an end of the leash. The buckle and leash connectors are provided as separate components on known and available collars and harnesses.

In certain instances, the collar or harness may include a traditional buckle having a pivoting prong that is received in one of several spaced holes in an end of a strap to be connected by the buckle. These buckles are effective at creating a desired length of the collar or harness strap, but can be difficult to use. Alternatively, quick release buckles may be provided on the collar or harness, which may include depressible side members that allow a first portion of the buckle to be removed from a second portion of the buckle. While these quick release buckles are somewhat effective at alleviating the deficiencies of the traditional buckle, they are generally not strong and therefore are not always acceptable on collars and harnesses for most dogs.

Leash connectors are typically provided on collars and harnesses in the form of an O ring or D ring that is secured to the webbing of the collar or harness during manufacturing. These leash connectors are effective at providing a connection point between the collar or harness and the leash, but they are to the component and manufacturing costs of the products.

There is a need in the art for an improved buckling device that alleviates one or more of the deficiencies of the prior art.

### DISCLOSURE OF THE INVENTION

It is thus an object of one aspect of the present invention to make a buckle with two mating portions.

It is an object of another aspect of the invention to provide a buckle, as above, wherein the mating portions are identical thereby saving manufacturing costs.

It is an object of yet another aspect of the present invention to provide a buckle, as above, in which the mating portions are easily magnetically connected.

It is an object of an additional aspect of the present invention to provide a buckle, as above, which is particularly useful for pet collars, harnesses or the like.

It is an object of a further aspect of the present invention to provide a buckle, as above, which also forms a leash connector when the mating portions are connected.

It is an object of yet another aspect of the present invention to provide a buckle, as above, which is easy and cost efficient to manufacture.

These and other objects of the present invention, as well as the advantages thereof over existing prior art forms, which will become apparent from the description to follow, are accomplished by the improvements hereinafter described and claimed.

In general, a buckle made in accordance with the present invention includes a first portion having a magnet, a hook and a slot, and a second portion having a magnet, a hook and a slot. The magnets of the first and second portions are selectively positionable adjacent to each other. The hook of the first portion is selectively received in the slot of the second portion, and the hook of the second portion is selectively received in the slot of the first portion to attach the first portion to the second portion.

In accordance with another aspect of the invention, a collar includes a strap having first and second ends. A buckle has a first portion which is carried by the first strap end, and a second portion of the buckle is carried by the second strap end. The first portion has a magnet, a hook and a slot, and the second portion has a magnet, a hook and a slot. The magnets of the first and second portions are selectively positionable adjacent to each other. The hook of the first portion is selectively received in the slot of the second portion, and the hook of the second portion is selectively received in the slot of the first portion to attach the first portion to the second portion thereby attaching the first end of the strap to the second end of the strap.

A preferred buckle for a strap, such as a pet collar, made in accordance with the present invention is shown by way of example in the accompanying drawings without attempting to show all the various forms and modifications in which the invention might be embodied, the invention being measured by the appended claims and not by the details of the specification.

### BRIEF DESCRIPTION OF THE DRAWINGS

FIG. 1 is a bottom, front, left side perspective view of one of two identical portions of a buckle made in accordance with the present invention.

FIG. 2 is a top, rear, right side perspective view thereof.

FIG. 3 is a top, rear, left side perspective view thereof.

FIG. 4 is a front elevational view thereof.

FIG. 5 is a sectional view taken substantially along line 5-5 of FIG. 4.

FIG. 6 is a front, top, right side perspective view of a metallic component of each portion of the buckle.

FIG. 7 is a perspective representation showing the manner in which the two buckle portions go together to form the buckle of the present invention.

FIG. 8 is a perspective view of a buckle made in accordance with the present invention and shown as being formed by the identical buckle portions shown in FIGS. 1-4.

FIG. 9 is a side elevational view of the buckle of FIG. 8 showing the manner in which it is used with a pet collar.

### PREFERRED EMBODIMENT FOR CARRYING OUT THE INVENTION

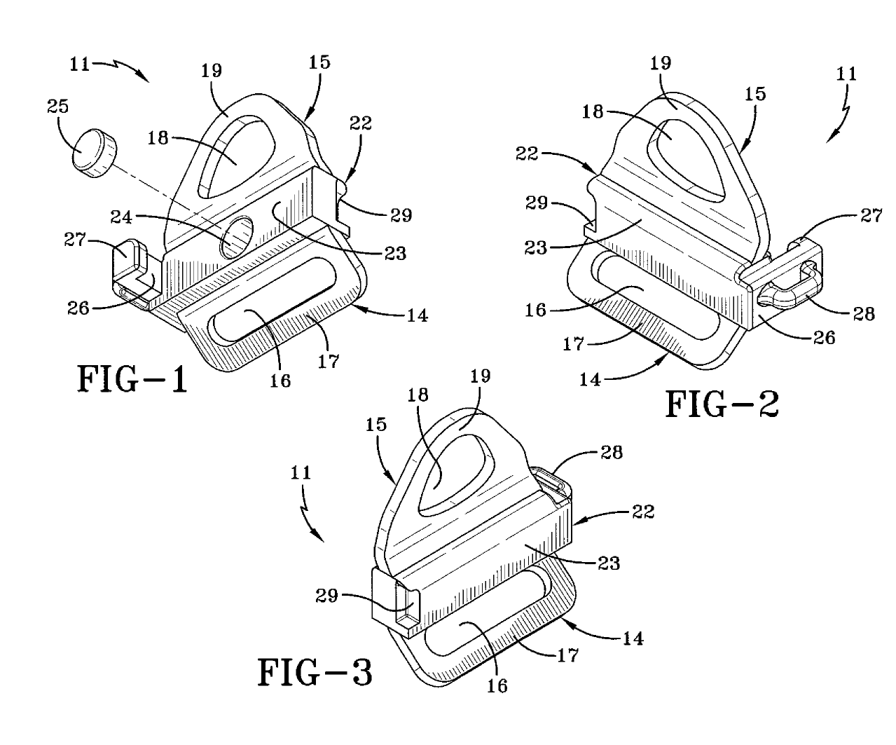

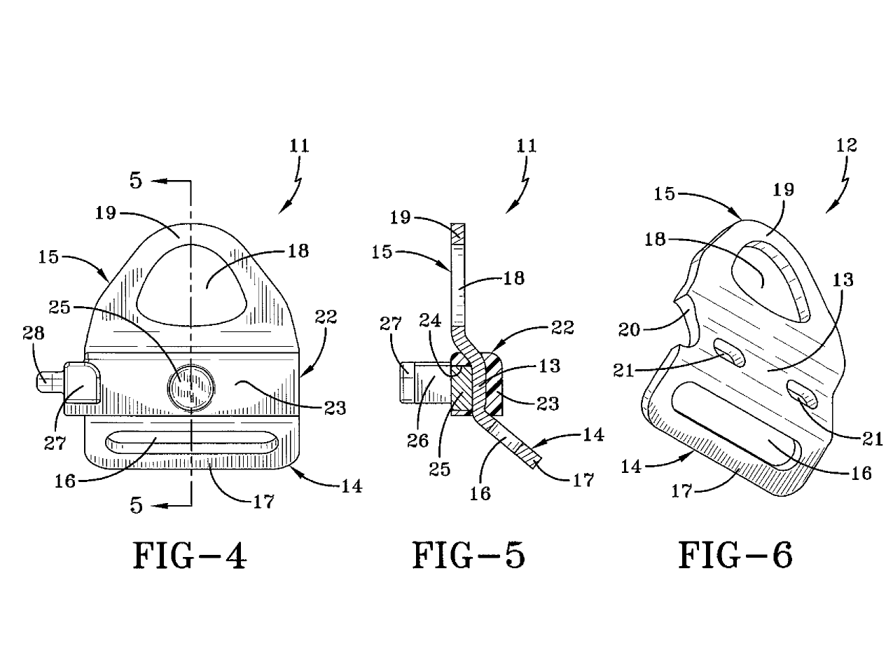

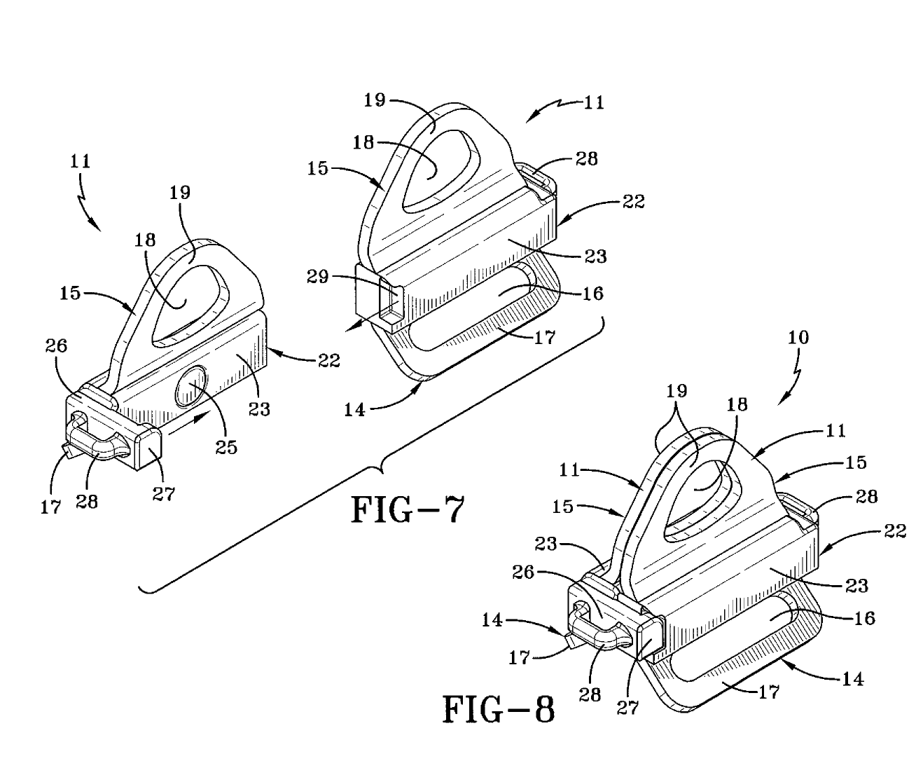

A buckle made in accordance with the concepts of the present invention is shown in FIG. 8 and indicated generally by the numeral 10. Buckle 10 may be formed of identical portions generally indicated by the numeral 11 and shown in FIGS. 1-4, each of which form half of buckle 10. However, it is not critical that portions 11 be totally identical.

Each buckle portion 11 includes a preferably metallic base member generally indicated by the numeral 12 and shown in FIG. 6. Base member 12 includes a central body 13 with flanges 14 and 15 extending from opposed edges of body 13. Flange 14 has an elongate slot 16 formed therein which creates a bar 17 at the outer edge of flange 14. Flange 15 is shown as being somewhat spade-shaped having a correspondingly shaped opening 18 formed therein creating a curved bar 19. Central body 13 has a scalloped edge 20 and at least one, and preferably two, openings 21 extending therethrough. A plastic cover, generally indicated by the numeral 22, is molded around at least central body 13 to form a finished buckle portion 11, and edge 20 and openings 21 promote the flow of the plastic during the molding process. If desired, cover 22 may be molded around flange 14 and/or flange 15.

Cover 22 includes a body member 23 which extends around the entire periphery of central body 13 of metallic base member 12. As best shown in FIG. 1, on the front side of buckle portion 11, body member 23 has an opening 24 therein to receive a magnet 25. Also on that front side, a tab 26 is formed which extends outwardly away from an end of body member 23. A projection 27 is formed at the end of tab 26 and it extends back over body portion 23 and is spaced therefrom to form a hook. As best seen in FIG. 2, a loop 28 is optionally formed on the side of tab 26 opposite to the side having the hook. On the back side of buckle portion 11, a slot 29 is formed on the side opposite to that of the hook, as most clearly shown in FIG. 3.

The manner in which the identical buckle portions 11 just described form buckle 10 is shown in FIG. 7. The portions 11 are positioned so that the front sides thereof having the magnets 25 face each other. Then the portions can be slid toward each other, as shown by the arrows in FIG. 7, until the magnets 25 attract and self align which attaches the portions 11 together. In addition, at this time, the projection 27 of one buckle portion 11 is received in the slot 29 of the other buckle portion 11 and the projection 27 of the other buckle portion 11 is received in the slot 29 of the one buckle portion 11. Such connections, coupled with the magnetic force, will maintain portions 11 together until the process is reversed to overcome the magnetic force and separate the two portions 11.

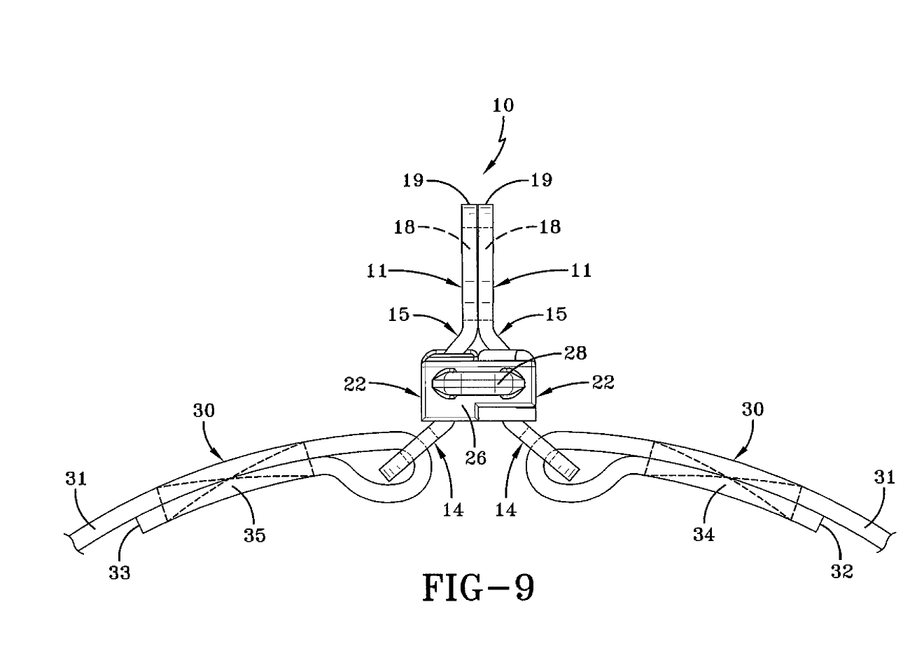

Shown in FIG. 9 is the manner in which the buckle 10 can be used to attach the ends of a strap, such as a pet collar, fragmentally and somewhat schematically shown and generally indicated by the numeral 30. Collar 30 typically can be formed of a continuous strap 31 of material, such as nylon, leather, or the like, having a first end 32 and a second end 33. One end of strap 31, such as first end 32, can be threaded through the slot 16 of one buckle portion 11, looped around its bar 17, and attached to itself as by stitching 34. Similarly, second end 33 can be threaded through the slot 16 of the other buckle portion 11, looped around its bar 17, and attached to itself as by stitching 35. As a result, when buckle portions 11 are separated from each other as previously described, one buckle portion 11 will remain with one strap and the other buckle portion 11 will remain with the other buckle end.

While pet collar 30 typically has other components, such as a length adjuster or the like, when buckle 10 is used with a pet collar 30, there is no need for collar 30 to have a conventional leash connector because the mating flanges 15 create an opening by virtue of the mating openings 18 such that a convention clip on the end of a leash can be clipped over aligned bars 19 and through aligned openings 18. Moreover, if desired, loops 28 on each side of buckle 10 may be used to attach other items, such as license tags, name tags, or the like, to collar 30.

In view of the forgoing, it should be evident that a buckle and collar as described herein accomplishes the objects of the present invention and otherwise substantially improves the art.

What is claimed is:

1. A buckle comprising a first portion having a magnet, a hook and a slot; and a second portion having a magnet, a hook and a slot; said magnets of said first and second portions being selectively positionable adjacent to each other, said hook of said first portion being selectively received in said slot of said second portion, and said hook of said second portion being selectively received in said slot of said first portion to attach said first portion to said second portion.

2. The buckle according to claim 1, said first and second portions each having a body member carrying said magnets and having said hooks and said slots formed thereon.

3. The buckle according to claim 2 further comprising a flange extending outwardly from each said body member, each said flange having a slot thereon.

4. The buckle according to claim 2 further comprising a flange extending outwardly from each said body member, each said flange having an aperture therein, said aperture of said first portion being aligned with said aperture of said second portion when said first and second portions are attached to each other.

5. The buckle according to claim 2 further comprising a loop formed on each said body member.

6. The buckle according to claim 1 wherein said first and second portions each include a base member having a central portion, a first flange extending in one direction from said central portion, and a second flange extending in another direction from said central portion.

7. The buckle according to claim 6 further comprising a slot through each said first flange.

8. The buckle according to claim 7 further comprising an aperture in each said second flange, said aperture of said second flange of said base member of said first portion being aligned with said aperture of said second flange of said base member of said second portion when said first and second portions are attached to each other.

9. The buckle according to claim 6, said first and second portions each having a body member formed on said base member, said body members carrying said magnets and having said hooks and said slots formed thereon.

10. The buckle according to claim 9 wherein said base members are made of a metallic material and said body members are made of a plastic material molded onto said central portions.

11. The buckle according to claim 10 further comprising at least one opening in said central portions for promoting the attachment of said plastic body members to said metallic base members.

12. The buckle according to claim 1 wherein said first and second portions are generally identical.

13. A collar comprising a strap having first and second ends; a buckle having a first portion carried by said first strap end and a second portion carried by said second strap end; said first portion having a magnet, a hook and a slot; said second portion having a magnet, a hook and a slot; said magnets of said first and second portions being selectively positionable adjacent to each other, said hook of said first portion being selectively received in said slot of said second portion, and said hook of said second portion being selectively received in said slot of said first portion to attach said first portion to said second portion thereby attaching said first end of said strap to said second end of said strap.

14. The collar according to claim 13, said first and second portions each having a body member carrying said magnets and having said hooks and said slots formed thereon.

15. The collar according to claim 14 further comprising a flange extending outwardly from each said body member, each said flange having a slot therein creating a bar, said first strap end extending around said bar and through said slot of said first portion, and said second strap end extending around said bar and through said slot of said second portion.

16. The collar according to claim 14 further comprising a flange extending outwardly from each said body member, each said flange having an aperture therein creating a bar, said apertures and said bars being adjacent to each other when said first and second portions are attached to each other to form a leash connector for the collar.

17. The collar according to claim 14 wherein said first and second portions each include a base member having a central portion and a first flange extending in one direction from said central portion and a second flange extending in another direction from said central portion.

18. The collar according to claim 17 further comprising a slot through each said first flange creating a bar, said first strap end extending around said bar and through said slot of said first portion, and said second strap end extending around said bar and through said slot of said second portion.

19. The collar according to claim 18 further comprising an aperture through each said second flange creating a bar, said apertures and said bars of said second flanges being adjacent to each other when said first and second portions are attached to each other to form a leash connector for the collar.

20. The collar according to claim 17, said first and second portions each having a body member formed on said base member, said body members carrying said magnets and having said hooks and said slots formed thereon.
